(19) United States
(12) Patent Application Publication
(10) Pub. No.: US 2023/0394677 A1
(43) Pub. Date: Dec. 7, 2023

(54) IMAGE-BASED PEDESTRIAN SPEED ESTIMATION

(71) Applicant: FORD GLOBAL TECHNOLOGIES, LLC, Dearborn, MI (US)

(72) Inventors: Harpreet Banvait, Farmington Hills, MI (US); Guy Hotson, Mountain View, CA (US); Nicolas Cebron, Sunnyvale, CA (US); Michael Schoenberg, Seattle, WA (US)

(21) Appl. No.: 17/805,508

(22) Filed: Jun. 6, 2022

(51) Int. Cl. G06T 7/246; G06V 20/58; G06V 40/20; G06V 10/764; B60W 60/00

(52) U.S. Cl. CPC G06T 7/246; G06V 20/58; G06V 40/25; G06V 10/764; B60W 60/0027; G06T 2207/20081; G06T 2207/30196; G06T 2207/30261; B60W 2554/4029; B60W 2554/4042; B60W 2420/42

(57) ABSTRACT

This document discloses system, method, and computer program product embodiments for image-based pedestrian speed estimation. For example, the method includes receiving an image of a scene, wherein the image includes a pedestrian and predicting a speed of the pedestrian by applying a machine-learning model to at least a portion of the image that includes the pedestrian. The machine-learning model is trained using a data set including training images of pedestrians, the training images associated with corresponding known pedestrian speeds. The method further includes providing the predicted speed of the pedestrian to a motion-planning system that is configured to control a trajectory of an autonomous vehicle in the scene.

### BACKGROUND

Autonomous vehicles (AVs) offer a range of potential benefits to society and to individuals such as mobility solutions for those who cannot drive themselves in the form of ride-sharing or autonomous taxi services, and reducing the number of road collisions that stem from errors in human judgment. AVs also provide plausible solutions to the issue of overcrowded highways as connected cars will communicate with each other and navigate an effective route based on real-time traffic information, making better use of road space by spreading demand. Augmenting human-operated features with AV capabilities also have benefits, as according to the National Highway Traffic Safety Administration (NHTSA), 94% of all collisions are due to human error.

When AVs operate they use various sensors to detect other actors in or near their path. Some actors, such as pedestrians may appear suddenly, out of occluded areas—for example, from between two parked cars—and not necessarily near a “Pedestrian Crossing” sign or walkway. In addition, because pedestrians' physical features fall in a wide range and because pedestrians appear in different environments, sufficient accuracy of recognition is a challenge for modern sensors. Improved methods to detect and estimate the speed of pedestrians are therefore desirable.

This document describes methods and systems that are directed to addressing the problems described above, and/or other issues.

### SUMMARY

The details of one or more aspects of the disclosure are set forth in the accompanying drawings and the description below. Other features, objects, and advantages of the techniques described in this disclosure will be apparent from the description and drawings, and from the claims.

The present disclosure describes embodiments related to image-based pedestrian speed estimation.

A method includes receiving an image of a scene (wherein the image includes a pedestrian) and predicting a speed of the pedestrian by applying a machine-learning model to at least a portion of the image that includes the pedestrian. The machine-learning model is trained using a data set that includes training images of pedestrians, the training images associated with corresponding known pedestrian speeds. The method further includes providing the predicted speed of the pedestrian to a motion-planning system that is configured to control a trajectory of an autonomous vehicle in the scene.

Implementations of the disclosure may include one or more of the following optional features. In some implementations, predicting the speed of the pedestrian is performed by applying the machine-learning model to the image and no additional images. Predicting the speed of the pedestrian may further include determining a confidence level associated with the predicted speed and providing the confidence level to the motion-planning system. Determining the confidence level associated with the predicted speed may further include predicting a speed of the pedestrian in a second image by applying the machine-learning model to at least a portion of the second image and comparing the predicted speed of the pedestrian in the second image to the predicted speed of the pedestrian in the received image. In some examples, the method further includes capturing the image by one or more sensors of the autonomous vehicle moving in the scene. Predicting the speed of the pedestrian may be done in response to detecting the pedestrian within a threshold distance of the autonomous vehicle. In some examples, detecting the pedestrian in the portion of the captured image includes extracting one or more features from the image, associating a bounding box or cuboid with the extracted features (the bounding boxes or cuboids defining a portion of the image containing the extracted features) and applying a classifier to the portion of the image within the bounding box or cuboid, the classifier configured to identify images of pedestrians.

In an embodiment, a system is disclosed. The system includes memory and at least one processor coupled to the memory and is configured to receive an image of a scene, the image including a pedestrian. The system is further configured to predict a speed of the pedestrian by applying a machine-learning model to at least a portion of the image that includes the pedestrian. The machine-learning model is trained using a data set that includes training images of pedestrians, the training images associated with corresponding known pedestrian speeds. The system is further configured to provide the predicted speed of the pedestrian to a motion-planning system that is configured to control a trajectory of an autonomous vehicle in the scene.

Implementations of the disclosure may include one or more of the following optional features. In some implementations, the at least one processor is configured to predict the speed of the pedestrian by applying the machine-learning model to the image and no additional images. The at least one processor may be further configured to determine a confidence level associated with the predicted speed and provide the confidence level to the motion-planning system. The at least one processor may be configured to determine the confidence level associated with the predicted speed by predicting a speed of the pedestrian in a second image (by applying the machine-learning model to at least a portion of the second image) and comparing the predicted speed of the pedestrian in the second image to the predicted speed of the pedestrian in the received image. The system may further include one or more sensors configured to capture the image. The at least one processor may be configured to predict the speed of the pedestrian in response to detecting the pedestrian within a threshold distance of the autonomous vehicle.

In an embodiment, a non-transitory computer-readable medium is disclosed. The non-transitory computer-readable medium stores instructions that are configured to, when executed by at least one computing device, cause the at least one computing device to perform operations. The operations include receiving an image of a scene, wherein the image includes a pedestrian and predicting a speed of the pedestrian by applying a machine-learning model to at least a portion of the image that includes the pedestrian. The machine-learning model is trained using a data set that includes training images of pedestrians, the training images associated with corresponding known pedestrian speeds. The operations further include providing the predicted speed of the pedestrian to a motion-planning system that is configured to control a trajectory of an autonomous vehicle in the scene.

Implementations of the disclosure may include one or more of the following optional features. In some implementations, predicting the speed of the pedestrian is performed by applying the machine-learning model to the image and no additional images. Predicting the speed of the pedestrian may further include determining a confidence level associated with the predicted speed and providing the confidence level to the motion-planning system. Determining the confidence level associated with the predicted speed may include predicting a speed of the pedestrian in a second image by applying the machine-learning model to at least a portion of the second image and comparing the predicted speed of the pedestrian in the second image to the predicted speed of the pedestrian in the received image. In some examples, the instructions cause the at least one computing device to perform operations further including capturing the image by one or more sensors of the autonomous vehicle. Predicting the speed of the pedestrian may be done in response to detecting the pedestrian within a threshold distance of the autonomous vehicle. Detecting the pedestrian in the portion of the captured image may include extracting one or more features from the image, associating a bounding box or cuboid with the extracted features (the bounding boxes or cuboids defining a portion of the image containing the extracted features), and applying a classifier to the portion of the image within the bounding box or cuboid, the classifier configured to identify images of pedestrians.

### BRIEF DESCRIPTION OF THE DRAWINGS

The accompanying drawings are incorporated into this document and form a part of the specification.

FIG. 1 illustrates an example autonomous vehicle system, in accordance with aspects of the disclosure.

FIG. 2 is a block diagram that illustrates example subsystems of an autonomous vehicle.

FIG. 3 illustrates example training data.

FIG. 4 shows a flowchart of a method of predicting the speed of a pedestrian.

FIG. 5 illustrates an example architecture for a vehicle, in accordance with aspects of the disclosure.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

This document describes system, apparatus, device, method and/or computer program product embodiments, and/or combinations and sub-combinations of any of the above, for estimating the speed of a pedestrian from an image. To effectively coexist with pedestrians, autonomous vehicles (or other self-guided robotic systems such as delivery robots) must account for pedestrians while planning and executing their route. Because pedestrians may be particularly vulnerable, autonomous vehicle navigation or motion-planning systems may maneuver the autonomous vehicle so as to maintain a threshold distance between the vehicle and pedestrian (or a predicted future location of the pedestrian).

Pedestrians often occupy particular locations within the environment, including (but not limited to) sidewalks that are adjacent to a roadway. These locations are generally separated from the path of autonomous vehicles except at well-defined points of intersection, such as pedestrian crosswalks across a roadway. However, pedestrians may also jaywalk across the roadway at random locations or suddenly run into the roadway. Previously undetected pedestrians (and other similar actors, such as deer, dogs or other animals) may suddenly emerge from areas wholly or partially obscured by parked cars, billboards or other signs, mailboxes, the edge of a forest adjacent to a roadway, etc. At the moment they first become detectable, they may be moving at any of a wide variety of speeds, depending on the circumstances. Speeds may vary from stationary or nearly stationary, through a leisurely stroll, a normal walking pace, a jog, or even a full sprint, such as when chasing after a runaway ball or when being chased. Furthermore, pedestrian speeds may suddenly change and in unpredictable ways. In settings such as crowded city streets, the sheer number of pedestrians to monitor within a scene can be quite large. Even more rural settings may also include circumstances where a large number of unpredictable actors must be accounted for, such as people at a bus stop, or road-crossing locations frequented by wild animals.

It is beneficial, therefore, for the motion-planning system of an autonomous vehicle to quickly predict speeds of each of several pedestrians in the scene, e.g., as soon as reasonably possible after each pedestrian is detected. The further in advance that an autonomous vehicle can predict the speed of a pedestrian, the sooner the autonomous vehicle can account for the pedestrian when planning and executing its route. However, earlier estimates may be based on less information and may have associated higher degrees of uncertainty. Therefore, it is further beneficial for the motion-planning system to obtain an error estimate associated with the predicted speed for each pedestrian, perhaps particularly in pedestrian-rich environments (such as the aforementioned crowded city streets and/or bus stops) where each individual pedestrian may be continually and abruptly changing their speed. An autonomous-vehicle motion-planning system which is able to rapidly obtain and update speed estimates and associated confidence factors for a large number of pedestrian and/or pedestrian-like actors may be able to more effectively plan and execute routes than a human could under similar circumstances. Furthermore, the autonomous-vehicle motion-planning system may also outperform systems having more accurate methods of speed estimation, such as tracking actors over a period of time (and several images) to estimate their speed. Such systems inherently require the period of time to estimate pedestrian speed, thus reducing available reaction time of the motion-planning system. The speed-estimation method may be so time consuming that by the time the accurate speed estimate is complete, the time budget for reacting to the speed estimate may already be exhausted. This document describes systems and methods that address these issues.

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” means “including, but not limited to.”

In this document, the term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

This document uses the term “pedestrian” to include any living actor that is moving or who may move in a scene without riding in a vehicle. The actor may be a human or an animal. The actor may be moving by walking, running, or by using partially or fully human-powered motion assistance items that require human movement for operation, such as roller skates, skateboards, manually-operated scooters and the like.

Definitions for additional terms that are relevant to this document are included at the end of this Detailed Description.

Notably, this document describes the present solution in the context of an AV. However, the present solution is not limited to AV applications.

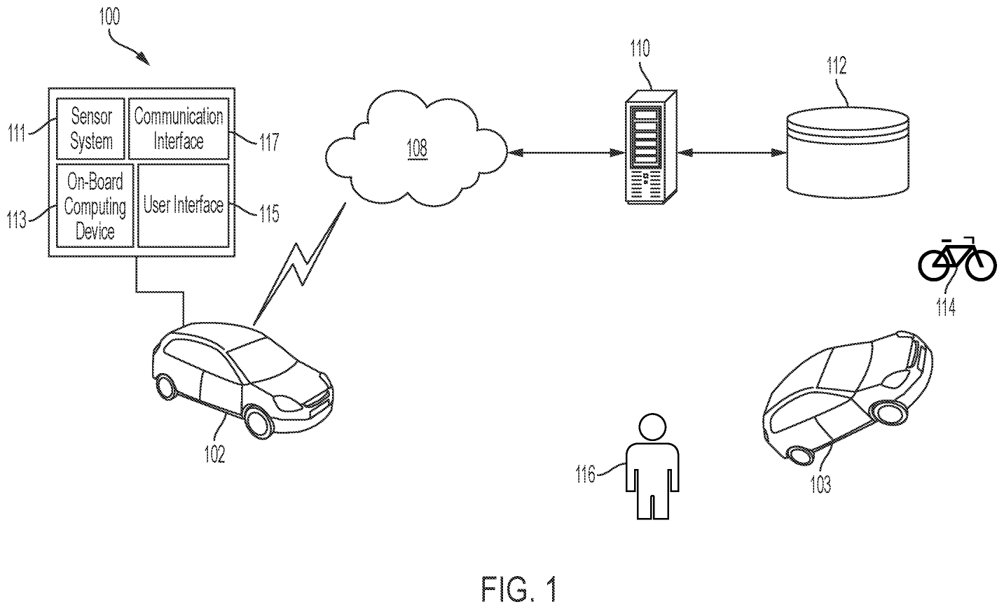

FIG. 1 illustrates an example system 100, in accordance with aspects of the disclosure. System 100 includes a vehicle 102 that is traveling along a road in a semi-autonomous or autonomous manner. Vehicle 102 is also referred to in this document as AV 102. AV 102 can include, but is not limited to, a land vehicle (as shown in FIG. 1), an aircraft, or a watercraft. As noted above, except where specifically noted this disclosure is not necessarily limited to AV embodiments, and it may include non-autonomous vehicles in some embodiments.

AV 102 is generally configured to detect objects in its proximity. The objects can include, but are not limited to, a vehicle 103, cyclist 114 (such as a rider of a bicycle, electric scooter, motorcycle, or the like) and/or a pedestrian 116.

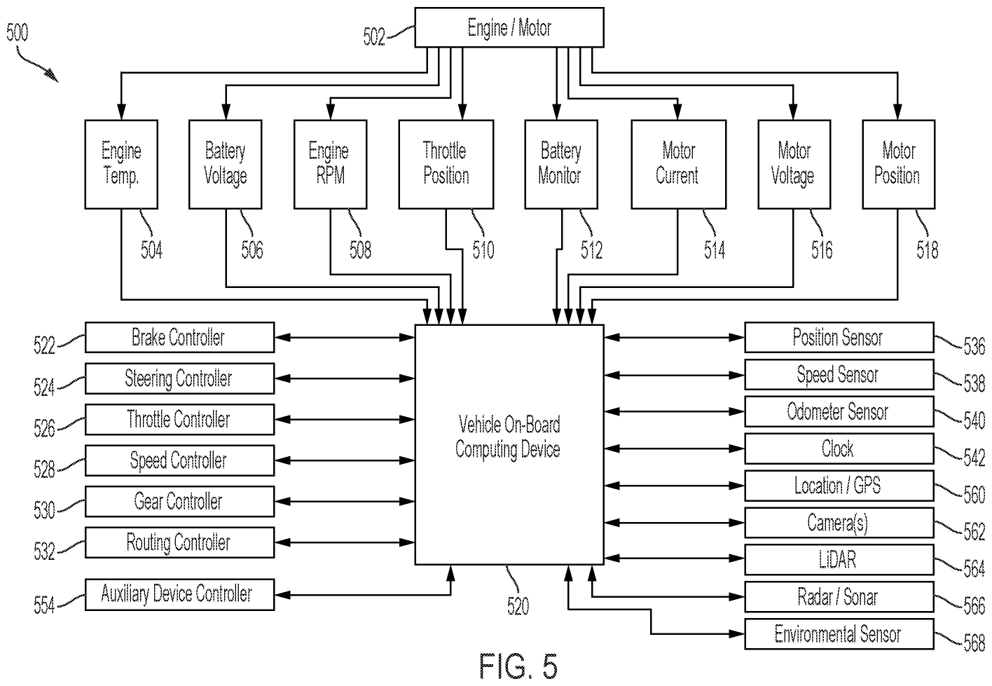

As illustrated in FIG. 1, the AV 102 may include a sensor system 111, an on-board computing device 113, a communication interface 117, and a user interface 115. Autonomous vehicle system 100 may further include certain components (as illustrated, for example, in FIG. included in vehicles, which may be controlled by the on-board computing device 113 (e.g., vehicle on-board computing device 520 of FIG. 5) using a variety of communication signals and/or commands, such as, for example, acceleration signals or commands, deceleration signals or commands, steering signals or commands, braking signals or commands, etc.

The sensor system 111 may include one or more sensors that are coupled to and/or are included within the AV 102. For example, such sensors may include, without limitation, a lidar system, a radio detection and ranging (radar) system, a laser detection and ranging (LADAR) system, a sound navigation and ranging (sonar) system, one or more cameras (for example, visible spectrum cameras, infrared cameras, etc.), temperature sensors, position sensors (for example, a global positioning system (GPS), etc.), location sensors, fuel sensors, motion sensors (for example, an inertial measurement unit (IMU), etc.), humidity sensors, occupancy sensors, or the like. The sensor data can include information that describes the location of objects within the surrounding environment of the AV 102, information about the environment itself, information about the motion of the AV 102, information about a route of the vehicle, or the like. As AV 102 travels over a surface, at least some of the sensors may collect data pertaining to the surface.

The AV 102 may also communicate sensor data collected by the sensor system to a remote computing device 110 (for example, a cloud processing system) over communications network 108. Remote computing device 110 may be configured with one or more servers to process one or more processes of the technology described in this document. Remote computing device 110 may also be configured to communicate data/instructions to/from AV 102 over network 108, to/from server(s) and/or database(s) 112.

Network 108 may include one or more wired or wireless networks. For example, the network 108 may include a cellular network (for example, a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (for example, the Public Switched Telephone Network (PSTN)), a private network, an ad hoc network, an intranet, the Internet, a fiber optic-based network, a cloud computing network, and/or the like, and/or a combination of these or other types of networks.

AV 102 may retrieve, receive, display, and edit information generated from a local application or delivered via network 108 from database 112. Database 112 may be configured to store and supply raw data, indexed data, structured data, map data, program instructions or other configurations as is known.

The communication interface 117 may be configured to allow communication between AV 102 and external systems, such as, for example, external devices, sensors, other vehicles, servers, data stores, databases, etc. The communication interface 117 may utilize any now or hereafter known protocols, protection schemes, encodings, formats, packaging, etc. such as, without limitation, Wi-Fi, an infrared link, Bluetooth, etc. The user interface system 115 may be part of peripheral devices implemented within the AV 102 including, for example, a keyboard, a touch screen display device, a microphone, and a speaker, etc. The vehicle also may receive state information, descriptive information or other information about devices or objects in its environment via the communication interface 117 over communication links such as those known as vehicle-to-vehicle, vehicle-to-object or other V2X communication links. The term “V2X” refers to a communication between a vehicle and any object that the vehicle may encounter or affect in its environment.

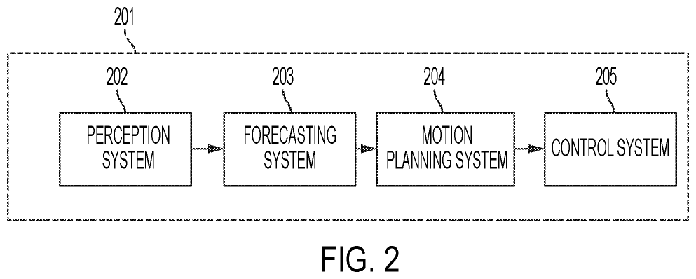

FIG. 2 shows a high-level overview of vehicle subsystems that may be relevant to the discussion above. Specific components within such systems will be described in the discussion of FIG. 5 in this document. Certain components of the subsystems may be embodied in processor hardware and computer-readable programming instructions that are part of the vehicle on-board computing system 201.

The subsystems may include a perception system 202 that includes sensors that capture information about moving actors and other objects that exist in the vehicle's immediate surroundings. Example sensors include cameras, lidar sensors and radar sensors. The data captured by such sensors (such as digital image, lidar point cloud data, or radar data) is known as perception data. The perception data may include data representative of one or more objects in the environment. The perception system may include one or more processors, along with a computer-readable memory with programming instructions and/or trained artificial intelligence models that, during a run of the vehicle, will process the perception data to identify objects and assign categorical labels and unique identifiers to each object detected in a scene. Categorical labels may include categories such as vehicle, cyclist, pedestrian, building, and the like. Methods of identifying objects and assigning categorical labels to objects are well known in the art, and any suitable classification process may be used, such as those that make bounding box (or, e.g., cuboid) predictions for detected objects in a scene and use convolutional neural networks or other computer vision models. Some such processes are described in “Yurtsever et al., A Survey of Autonomous Driving: Common Practices and Emerging Technologies” (arXiv Apr. 2, 2020).

If the vehicle is an AV 102, the vehicle's perception system 202 may deliver perception data to the vehicle's forecasting system 203. The forecasting system (which also may be referred to as a prediction system) will include processors and computer-readable programming instructions that are configured to process data received from the perception system and forecast actions of other actors that the perception system detects. For example, the forecasting system 203 may include a machine-learning model training to predict the speed of any or all pedestrians 116 (or other actors) based on an image (or portion of an image) in which the perception system detected the pedestrian 116 (or other actor).

In an AV 102, the vehicle's perception system, as well as the vehicle's forecasting system, will deliver data and information to the vehicle's motion planning system 204 and motion control system 205 so that the receiving systems may assess such data and initiate any number of reactive motions to such data. The motion planning system 204 and control system 205 include and/or share one or more processors and computer-readable programming instructions that are configured to process data received from the other systems, determine a trajectory for the vehicle, and output commands to vehicle hardware to move the vehicle according to the determined trajectory. Example actions that such commands may cause the vehicle hardware to take include causing the vehicle's brake control system to actuate, causing the vehicle's acceleration control subsystem to increase speed of the vehicle, or causing the vehicle's steering control subsystem to turn the vehicle. Various motion planning techniques are well known, for example as described in Gonzalez et al., “A Review of Motion Planning Techniques for Automated Vehicles,” published in IEEE Transactions on Intelligent Transportation Systems, vol. 17, no. 4 (April 2016).

In some embodiments, perception data (e.g., images of the environment captured by cameras or other imaging sensors of the AV 102) includes information relating to one or more pedestrians 116 in the environment. The on-board computing device 113 may process the camera images to identify the pedestrians 116 and may perform one or more prediction and/or forecasting operations related to the identified pedestrians 116. For example, the on-board computing device 113 may predict the speed of each identified pedestrian 116 based on the camera images, and may determine a motion plan for the autonomous vehicle 102 based on the prediction.

In some examples, the on-board computing device 113 receives one or more camera images of the environment (scene) surrounding in the AV 102 or within which the AV 102 is operating. The images may represent what an ordinary driver would perceive in the surrounding environment, and may also include information that an ordinary driver would be unable to perceive unaided, such as images acquired from advantageous locations on the AV 102 or from advantageous angles or points of view. The images may also be acquired at higher resolution that can be perceived by a human eye.

In some examples, the on-board computing device 113 processes the images to identify objects and assign categorical labels and unique identifiers to each object detected in a scene, as described above. Example categorical labels include “pedestrian” and “vehicle.” In some examples, categorical labels include other type of actors, including “cyclist” and/or “animal.” The on-board computing device 113 may also surround detected objects (or other detected features) with a bounding box or cuboid, such that the object is contained within the bounding box or cuboid. By isolating objects within bounding boxes or cuboids, the on-board computing device 113 may separately process the portion of the image within each box, e.g., to predict state information related to each identified object. In the case of a cuboid, the orientation of the cuboid may define the direction of travel of the object. The on-board computing device 113 may further process objects categorized as pedestrians 116 to determine their speed. In some examples, the on-board computing device 113 may track the pedestrian over time. That is, the on-board computing device 113 may identify the same pedestrian 116 within images (or the portion of images contained within bounding boxes) captured at more than one time. The on-board computing device 113 may determine the position of the pedestrian 116 in the scene at multiple different times and calculate the speed of the pedestrian based on the change in position between the different times and the associated elapsed time. The accuracy of a prediction performed in this manner will generally increase as more time elapses between the two different times, but at the cost of greater latency. This greater latency may leave insufficient time for the AV's motion planning system 204 to generate an appropriate trajectory to cope with the pedestrian 116.

Instead (or in parallel with pedestrian tracking), the on-board computing device 113 may determine the speed of the pedestrian 116 based on a single image (or the portion of the single image contained within a bounding box), with minimal latency. In this way, the on-board computing device 113 may predict the speed of the pedestrian 116 earlier than possible using, e.g., the method of tracking the pedestrian 116 over multiple images, thus allowing more time for the motion-planning system to react. In some examples, the on-board computing device 113 uses a trained machine-learning model to predict the speed of the pedestrian 116. The model may be trained using a data set including representative images of pedestrians 116 moving at a variety of speeds. Each training image may be labeled with the known speed of the pedestrian 116, so that the model learns to recognize, in a single image, a likely speed of the pedestrian 116. The number of training images may be sufficiently large (e.g., 50,000 curated images) for the model to effectively differentiate between a variety of pedestrian speeds. The model may learn to recognize semantic cues exhibited by pedestrian moving at particular speeds. These semantic cues may be based at least on posture, gait, height, stride length, or even type of clothing worn by the pedestrian 116, e.g., athletic wear and/or running shoes vs. dress shoes. The data set may also include images of partially occluded pedestrians so that the model can effectively predict pedestrian speeds even when the pedestrians 116 are only partially visible in the image.

In some examples, the training images include images acquired by an AV 102, e.g., in a real-world environment. The acquired images may be associated with accurately known (ground truth) pedestrian speeds, e.g., measured by tracking the position of the pedestrian 116 over a relatively long period of time. These training images may be acquired using a camera (or other imaging device) having characteristics which are substantially similar to the camera (or other imaging device) that will be used operationally by the AV 102. For instance, training images may be acquired using a camera at the same (or similar) position on the AV 102, aimed in the same (or similar) direction, with the same (or similar) focal length, field-of-view, or other acquisition characteristics as the operational camera of the AV 102. In some examples, the training images are images previously acquired by the AV 102. The previously acquired images may have been processed by the on-board computing device 113. The on-board computing device 113 may have identified pedestrians 116 in the image and may have applied bounding boxes around the pedestrians. The training images may include the portions of the images within the applied bounding boxes. These training images, acquired by the operational camera of the AV 102, and processed by the on-board computing device 113, may be visual as close as reasonably possible to the images (or image portions) that will be acquired during operation of the AV 102, thus enhancing the ability of the on-board computing device 113 to predict the speed of pedestrians 116. It may be less important to accurately predict the speed of pedestrians 116 who, when detected, are beyond a threshold distance (e.g., 25 meters) of the AV 102. Even at a full sprint, such a pedestrian 116 will take several seconds to become close to the AV 102. Such pedestrians 116 are less likely to require the AV's motion planning system 204 to immediately alter its trajectory to cope with them. Therefore, the curated set of training images may exclude pedestrians 116 who are beyond the threshold distance of the camera (e.g., as measured by a range-finding sensor such as LIDAR).

In addition to predicting the speed of the pedestrian 116, the machine learning model may also generate an error estimate or a confidence level associated with the speed prediction. The error estimate may be a distribution of individual prediction speeds associated with the curated training images. In some examples, each of the training images has its own, individual, associated error estimate. During operation, on-board computing device 113 may apply the trained machine-learning model to the image portion, so that the trained model accurately predicts the pedestrian speed and generates an associated error estimate. Alternatively, the machine learning model may be configured to classify images, e.g., into categories associated with ranges of pedestrian speeds. For example, each training image may have an associated hard label indicating one of a defined set of pedestrian speed ranges. The machine learning model, trained in this way, may classify a newly acquired image into one of the predefined pedestrian speed ranges.

The machine learning model may also generate a probability associated with the classification. In some examples, each training image may have one or more associated soft labels, each soft label indicating a probability that a pedestrian in the image is moving at a speed within a predefined range. In some examples, the on-board computing device 113 predicts a first speed of the pedestrian 116 based on a first image (or portion thereof) and predicts a second speed of the pedestrian 116 based on a first image (or portion thereof). The on-board computing device 113 may generate an error estimate based on the two predicted speed. For example, the error estimate may be lower if the two predictions are similar. Furthermore, the on-board computing device 113 may track the pedestrian 116 over multiple images, and generate the error estimate based on the standard deviation of predicted pedestrian speeds over the multiple images.

In some examples, the motion planning system 204 may receive pedestrian speed estimates from multiple sources. Each speed estimate may have an associated confidence level. The motion planning system 204 may combine the estimates, taking into account the confidence level associated with each estimate, when planning the route of the AV 102. For example, the motion planning system 204 may rely solely on the image-based pedestrian speed estimate when that estimate is the only available estimate for a pedestrian (e.g., when the first image of the pedestrian is acquired). After multiple images of the pedestrian 116 have been acquired the on-board computing device 113 may predict the pedestrian speed based on a change in position of the pedestrian 116 as the on-board computing device 113 tracks the pedestrian 116 from a first image to a subsequent image. The on-board computing device 113 may determine an associated error estimate based on the period of time between the subsequent images. The motion planning system 204 may combine the image-based estimate and the tracking-based estimate based on their associated error estimates. As more time passes, the tracking-based estimates may improve, and the motion planning system 204 may weigh those estimates higher in the combined estimate.

In some examples, the on-board computing device 113 uses multiple trained machine-learning models, each model associated a class of actors (e.g., pedestrian, cyclist, animal), to predict the speed of the actor. Each class of actor may exhibit different semantic cues when moving at various speeds, and may typically move at particular ranges of speeds. For example, cyclists 114 may not exhibit different gaits, but a cyclist's posture may provide cues as to the cyclist's speed, as may the degree of “blurring” of wheel spokes. Four-legged animal gaits may provide cues that are different than bipedal pedestrians 116.

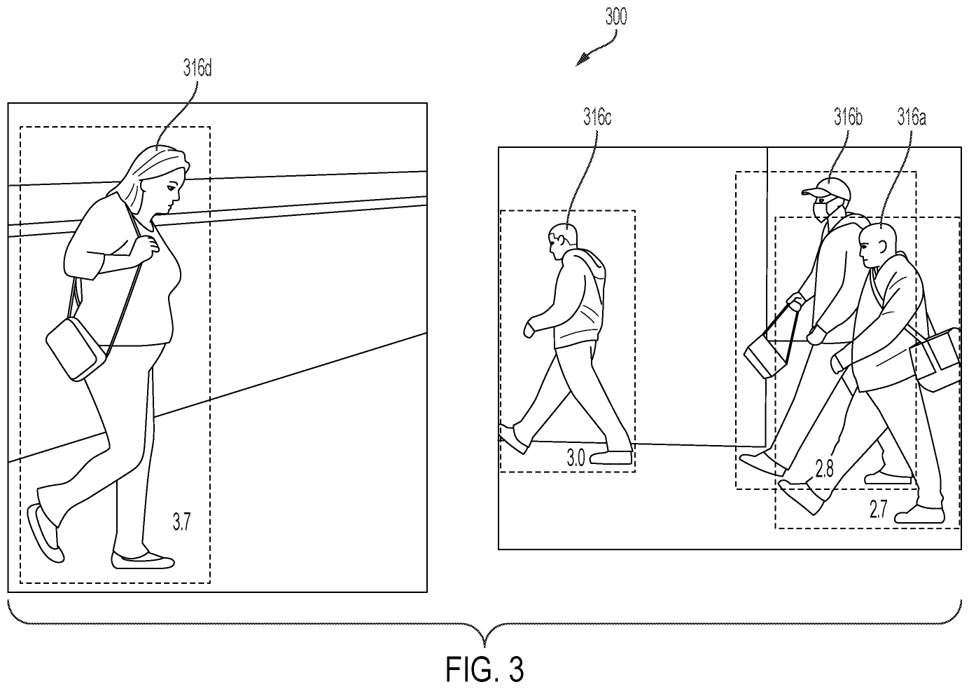

FIG. 3 shows example training data 300. The example training data 300 includes multiple images of pedestrians 316, 316a-316d in an environment, e.g., pedestrian 116 of FIG. 1. As previously discussed, a complete training set may include a large number (e.g., 5,000 or more) of curated images showing pedestrians 316 moving at a variety of representative speeds (or stationary), and in a variety of situations, including being partially obscured. The example training data 300 shows four pedestrians 316a-316d moving at a typical walking speed of between 3 and 4 miles per hour. Pedestrians 316a-316c are walking on a sidewalk adjacent to a roadway. Pedestrian 316d is crossing the roadway. As described above, each pedestrian 316a-316d has an associated accurately known (ground truth) velocity. The sufficiency of the training data may be validated through a number of approaches. For example, the training data may first be used to train the machine learning model, and then the trained model may be applied to the training data. The predictions of the trained machine-learning model may then be compared to ground truth speeds associated with the training data to assess the model's training. In some examples, the trained model is also applied to separate test data to assess the generality of the model's training.

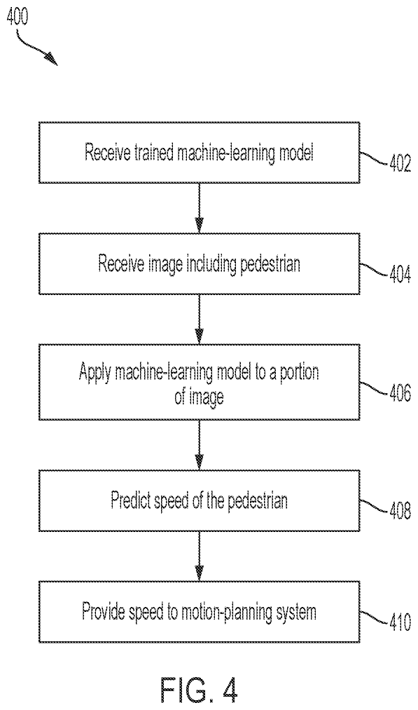

FIG. 4 shows a flowchart 400 of an example method of predicting pedestrian speed from an image. At step 402, the method includes receiving a trained machine-learning model. As described above, the machine-learning model may be trained using a data set including a curated set of training images. The data set may be sufficiently large, diverse, and representative that the model effectively differentiates between a variety of pedestrian speeds in a variety of circumstances. At step 404, the method includes receiving an image of a scene, e.g., from a camera of an AV 102, the image containing images of one or more pedestrians 116. The camera may be mounted on the AV 102 and configured to capture images of the environment surrounding the AV 102. In some examples, the image is received from a source that is external to the AV 102, such as another vehicle 103 (e.g., via vehicle-to-vehicle communication), or from a camera mounted on a traffic light or street light or other infrastructure and configured to capture images of the environment near the AV 102. Thus, the image may include regions of the environment that are obscured from view of occupants of the AV 102. At step 406, the method includes applying a machine-learning model to the image, or at least a portion of the image that includes the pedestrian 116. In some examples, the image is first processed to identify and/or extract features (such as pedestrians 116) and to apply bounding boxes or cuboids around the features. The portions of the image within each bounding box may be further processed, e.g., to classify or categorize the feature. For example, the on-board computing device 113 may apply a classifier that has been trained to identify images (or portions of images) containing features such as pedestrians 116. The classifier may apply a label to the image (or portion thereof) indicating the class of feature that the classifier identified. The on-board computing device 113 may track identified features across subsequently acquired images, e.g., until the feature is no longer detected in the scene.

At step 406, the method may include applying the machine-learning model to the portion of the image within the bounding box. In some examples, the method includes applying one or several machine-learning models to the portion of the image within the bounding box, e.g., based on the classification of the portion of the image, as described above. In some examples, the on-board computing device 113 applies the trained machine-learning model to the portion of the acquired image containing the only when the detected pedestrian 116 is within a threshold distance of the AV 102. The on-board computing device 113 may determine the distance of the pedestrian 116 to the AV 102 using a number of approaches, including range-finding, e.g., via radar or lidar, or by processing binocular images of the pedestrian 116. The on-board computing device 113 may also determine the distance of the pedestrian 116 to the AV 102 using image processing and/or artificial intelligence.

In some examples, the machine-learning model has been trained using a data set including training images of pedestrians 116 (or other pedestrian-like actors) moving at known speeds. At step 408, the method includes predicting the speed of the pedestrian 116 based on applying the trained machine-learning model. The method may further include determining a confidence level or uncertainty associated with the predicted speed, such as a probability determined by the machine-learning model. At step 410, the method includes providing the predicted speed to a motion-planning system 204 of the AV 102. The method may also include providing the confidence level associated with the predicted speed to the motion-planning system 204. In some examples, the predicted speed and/or confidence level are associated with the bounding box or cuboid applied around the feature, such that further (e.g., downstream) processing involving the cuboid can benefit from this information. In other words, the method may easily integrate with and enhance existing motion-planning systems 204. The on-board computing device 113 may determine a motion plan for the autonomous vehicle 102 based on the prediction(s). For example, the on-board computing device 113 may make decisions regarding how coping with objects and/or actors in the environment of the AV 102. To make its decision, the computing device 113 may take into account an estimated speed and/or trajectory of detected pedestrians 116 As well as error estimates (e.g., confidence levels) associated with each speed estimate.

FIG. 5 illustrates an example system architecture 500 for a vehicle, in accordance with aspects of the disclosure. Vehicles 102 and/or 103 of FIG. 1 can have the same or similar system architecture as that shown in FIG. 5. Thus, the following discussion of system architecture 500 is sufficient for understanding vehicle(s) 102, 103 of FIG. 1. However, other types of vehicles are considered within the scope of the technology described in this document and may contain more or less elements as described in association with FIG. 5. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 5, system architecture 500 for a vehicle includes an engine or motor 502 and various sensors 504-518 for measuring various parameters of the vehicle. In gas-powered or hybrid vehicles having a fuel-powered engine, the sensors may include, for example, an engine temperature sensor 504, a battery voltage sensor 506, an engine revolutions per minute (“RPM”) sensor 508, and a throttle position sensor 510. If the vehicle is an electric or hybrid vehicle, then the vehicle may have an electric motor, and accordingly includes sensors such as a battery monitoring system 512 (to measure current, voltage and/or temperature of the battery), motor current 514 and voltage 516 sensors, and motor position sensors 518 such as resolvers and encoders.

Operational parameter sensors that are common to both types of vehicles include, for example: a position sensor 536 such as an accelerometer, gyroscope and/or inertial measurement unit; a speed sensor 538; and an odometer sensor 540. The vehicle also may have a clock 542 that the system uses to determine vehicle time during operation. The clock 542 may be encoded into the vehicle on-board computing device, it may be a separate device, or multiple clocks may be available.

The vehicle also may include various sensors that operate to gather information about the environment in which the vehicle is traveling. These sensors may include, for example: a location sensor 560 (such as a Global Positioning System (“GPS”) device); object detection sensors such as one or more cameras 562; a lidar system 564; and/or a radar and/or a sonar system 566. The sensors also may include environmental sensors 568 such as a precipitation sensor and/or ambient temperature sensor. The object detection sensors may enable the vehicle to detect objects that are within a given distance range of the vehicle in any direction, while the environmental sensors collect data about environmental conditions within the vehicle's area of travel. Objects within detectable range of the vehicle may include stationary objects, such as buildings and trees, and moving (or potentially moving) actors, such as pedestrians.

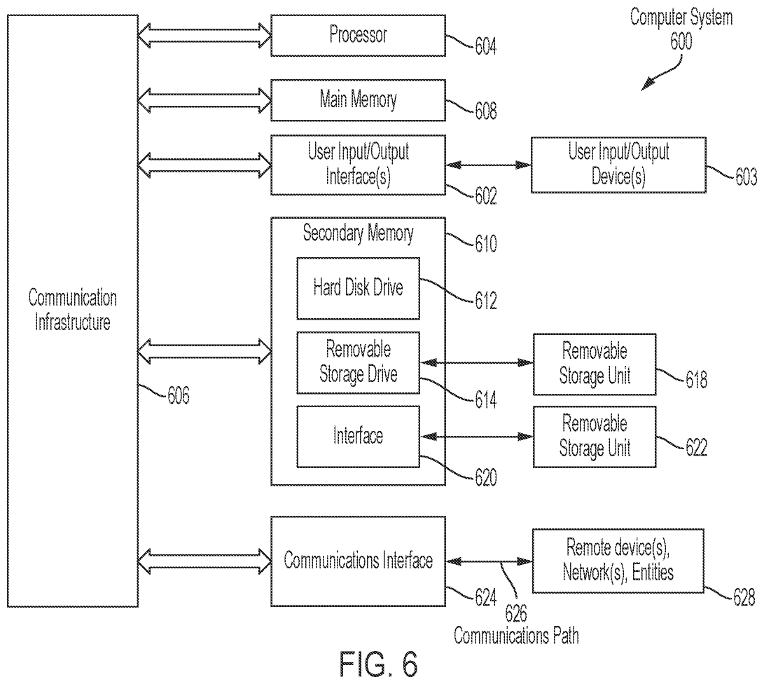

During operations, information is communicated from the sensors to a vehicle on-board computing device 520. The on-board computing device 520 may be implemented using the computer system of FIG. 6. The vehicle on-board computing device 520 analyzes the data captured by the sensors and optionally controls operations of the vehicle based on results of the analysis. For example, the vehicle on-board computing device 520 may control: braking via a brake controller 522; direction via a steering controller 524; speed and acceleration via a throttle controller 526 (in a gas-powered vehicle) or a motor speed controller 528 (such as a current level controller in an electric vehicle); a differential gear controller 530 (in vehicles with transmissions); and/or other controllers. Auxiliary device controller 554 may be configured to control one or more auxiliary devices, such as testing systems, auxiliary sensors, mobile devices transported by the vehicle, etc.

Geographic location information may be communicated from the location sensor 560 to the on-board computing device 520, which may then access a map of the environment that corresponds to the location information to determine known fixed features of the environment such as streets, buildings, stop signs and/or stop/go signals. Captured images from the cameras 562 and/or object detection information captured from sensors such as lidar system 564 is communicated from those sensors) to the on-board computing device 520. The object detection information and/or captured images are processed by the on-board computing device 520 to detect objects in proximity to the vehicle. Any known or to be known technique for making an object detection based on sensor data and/or captured images can be used in the embodiments disclosed in this document.

The on-board computing device 520 may include and/or may be in communication with a routing controller 532 that generates a navigation route from a start position to a destination position for an autonomous vehicle. The routing controller 532 may access a map data store to identify possible routes and road segments that a vehicle can travel on to get from the start position to the destination position. The routing controller 532 may score the possible routes and identify a preferred route to reach the destination. For example, the routing controller 532 may generate a navigation route that minimizes Euclidean distance traveled or other cost function during the route, and may further access the traffic information and/or estimates that can affect an amount of time it will take to travel on a particular route. Depending on implementation, the routing controller 532 may generate one or more routes using various routing methods, such as Dijkstra's algorithm, Bellman-Ford algorithm, or other algorithms. The routing controller 532 may also use the traffic information to generate a navigation route that reflects expected conditions of the route (e.g., current day of the week or current time of day, etc.), such that a route generated for travel during rush-hour may differ from a route generated for travel late at night. The routing controller 532 may also generate more than one navigation route to a destination and send more than one of these navigation routes to a user for selection by the user from among various possible routes.

In various embodiments, the on-board computing device 520 may determine perception information of the surrounding environment of the AV 102. Based on the sensor data provided by one or more sensors and location information that is obtained, the on-board computing device 520 may determine perception information of the surrounding environment of the AV 102. The perception information may represent what an ordinary driver would perceive in the surrounding environment of a vehicle. The perception data may include information relating to one or more objects in the environment of the AV 102. For example, the on-board computing device 520 may process sensor data (e.g., lidar or radar data, camera images, etc.) in order to identify objects and/or features in the environment of AV 102. The objects may include traffic signals, roadway boundaries, other vehicles, pedestrians, and/or obstacles, etc. The on-board computing device 520 may use any now or hereafter known object recognition algorithms, video tracking algorithms, and computer vision algorithms (e.g., track objects frame-to-frame iteratively over a number of time periods) to determine the perception.

In some embodiments, the on-board computing device 520 may also determine, for one or more identified objects in the environment, the current state of the object. The state information may include, without limitation, for each object: current location; current speed and/or acceleration, current heading; current pose; current shape, size, or footprint; type (for example: vehicle, pedestrian, bicycle, static object or obstacle); and/or other state information.

The on-board computing device 520 may perform one or more prediction and/or forecasting operations. For example, the on-board computing device 520 may predict future locations, trajectories, and/or actions of one or more objects. For example, the on-board computing device 520 may predict the future locations, trajectories, and/or actions of the objects based at least in part on perception information (e.g., the state data for each object including an estimated shape and pose determined as discussed below), location information, sensor data, and/or any other data that describes the past and/or current state of the objects, the AV 102, the surrounding environment, and/or their relationship(s). Furthermore, the computing device 520 may determine a confidence level associated with one or more predictions. For example, the computing device 520 may determine an error estimate associated with location, speed, direction, and/or other aspect of one or more perceived actors and use the error estimate to predict likely trajectories of the object. If an object is a vehicle and the current driving environment includes an intersection, the on-board computing device 520 may predict whether the object will likely move straight forward or make a turn and determine a likelihood associated with each possibility. If the perception data indicates that the intersection has no traffic light, the on-board computing device 520 may also predict whether the vehicle may have to fully stop prior to entering the intersection.

In various embodiments, the on-board computing device 520 may determine a motion plan for the autonomous vehicle. For example, the on-board computing device 520 may determine a motion plan for the autonomous vehicle based on the perception data and/or the prediction data. Specifically, given predictions about the future locations of proximate objects and other perception data, the on-board computing device 520 can determine a motion plan for the AV 102 that best navigates the autonomous vehicle relative to the objects at their future locations.

For example, for a particular actor (e.g., a vehicle with a given speed, direction, turning angle, etc.), the on-board computing device 520 decides whether to overtake, yield, stop, and/or pass based on, for example, traffic conditions, map data, state of the autonomous vehicle, etc. Furthermore, the on-board computing device 520 also plans a path for the AV 102 to travel on a given route, as well as driving parameters (e.g., distance, speed, and/or turning angle). That is, for a given object, the on-board computing device 520 determines how to cope with the object. For example, for a given object, the on-board computing device 520 may decide to pass the object and may determine whether to pass on the left side or right side of the object (including motion parameters such as speed). The on-board computing device 520 may also assess the risk of a collision between a detected object and the AV 102. If the risk exceeds an acceptable threshold, it may determine whether the collision can be avoided if the autonomous vehicle follows a defined vehicle trajectory and/or performs one or more dynamically generated emergency maneuvers within a pre-defined time period (e.g., N milliseconds). If the collision can be avoided, then the on-board computing device 520 may execute one or more control instructions to perform a cautious maneuver (e.g., mildly slow down, accelerate, change lane, or swerve). In contrast, if the collision cannot be avoided, then the on-board computing device 520 may execute one or more control instructions for execution of an emergency maneuver (e.g., brake and/or change direction of travel).

Various embodiments can be implemented, for example, using one or more computer systems, such as computer system 600 shown in FIG. 6. Computer system 600 can be any computer capable of performing the functions described in this document.

Computer system 600 includes one or more processors (also called central processing units, or CPUs), such as a processor 604. Processor 604 is connected to a communication infrastructure or bus 602. Optionally, one or more of the processors 604 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure through user input/output interface(s) 602.

Computer system 600 also includes a main or primary memory 608, such as random access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be an external hard drive, a universal serial bus (USB) drive, a memory card such as a compact flash card or secure digital memory, a floppy disk drive, a magnetic tape drive, a compact disc drive, an optical storage device, a tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be an external hard drive, a universal serial bus (USB) drive, a memory card such as a compact flash card or secure digital memory, a floppy disk, a magnetic tape, a compact disc, a DVD, an optical storage disk, and/any other computer data storage device. Removable storage drive 614 reads from and/or writes to removable storage unit 618 in a well-known manner.

According to an example embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In some embodiments, a tangible, non-transitory apparatus or article of manufacture including a tangible, non-transitory computer-useable or readable medium having control logic (software) stored thereon is also referred to in this document as a computer program product or program storage device. This includes, but is not limited to, computer system 600, main memory 606, secondary memory 610, and removable storage units 618 and 622, as well as tangible articles of manufacture embodying any combination of the foregoing. Such control logic, when executed by one or more data processing devices (such as computer system 600), causes such data processing devices to operate as described in this document.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described in this document.

Terms that are relevant to this disclosure include:

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices. The term “wireless communication” refers to communication between two devices in which at least a portion of the communication path includes a signal that is transmitted wirelessly, but it does not necessarily require that the entire communication path be wireless.

The term “classifier” means an automated process by which an artificial intelligence system may assign a label or category to one or more data points. A classifier includes an algorithm that is trained via an automated process such as machine learning. A classifier typically starts with a set of labeled or unlabeled training data and applies one or more algorithms to detect one or more features and/or patterns within data that correspond to various labels or classes. The algorithms may include, without limitation, those as simple as decision trees, as complex as Naïve Bayes classification, and/or intermediate algorithms such as k-nearest neighbor. Classifiers may include artificial neural networks (ANNs), support vector machine (SVM) classifiers, and/or any of a host of different types of classifiers. Once trained, the classifier may then classify new data points using the knowledge base that it learned during training. The process of training a classifier can evolve over time, as classifiers may be periodically trained on updated data, and they may learn from being provided information about data that they may have mis-classified. A classifier will be implemented by a processor executing programming instructions, and it may operate on large data sets such as image data, LIDAR system data, and/or other data.

A “machine learning model” or a “model” refers to a set of algorithmic routines and parameters that can predict an output(s) of a real-world process (e.g., prediction of an object trajectory, a diagnosis or treatment of a patient, a suitable recommendation based on a user search query, etc.) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems utilize various types of statistical analyses, machine learning systems are distinguished from statistical analyses by virtue of the ability to learn without explicit programming and being rooted in computer technology.

A typical machine learning pipeline may include building a machine learning model from a sample dataset (referred to as a “training set”), evaluating the model against one or more additional sample datasets (referred to as a “validation set” and/or a “test set”) to decide whether to keep the model and to benchmark how good the model is, and using the model in “production” to make predictions or decisions against live input data captured by an application service. The training set, the validation set, and/or the test set, as well as the machine learning model are often difficult to obtain and should be kept confidential. The current disclosure describes systems and methods for providing a secure machine learning pipeline that preserves the privacy and integrity of datasets as well as machine learning models.

The term “bounding box” refers to an axis-aligned rectangular box that represents the location of an object. A bounding box may be represented in data by x- and y-axis coordinates [xmax, ymax] that correspond to a first corner of the box (such as the upper right corner), along with x- and y-axis coordinates [xmin, ymin] that correspond to the corner of the rectangle that is opposite the first corner (such as the lower left corner). It may be calculated as the smallest rectangle that contains all of the points of an object, optionally plus an additional space to allow for a margin of error. The points of the object may be those detected by one or more sensors, such as pixels of an image captured by a camera, or points of a point cloud captured by a LiDAR sensor.

The term “object,” when referring to an object that is detected by a vehicle perception system or simulated by a simulation system, is intended to encompass both stationary objects and moving (or potentially moving) actors, except where specifically stated otherwise by use of the term “actor” or “stationary object.”

When used in the context of autonomous vehicle motion planning, the term “trajectory” refers to the plan that the vehicle's motion planning system 204 will generate, and which the vehicle's motion control system 205 will follow when controlling the vehicle's motion. A trajectory includes the vehicle's planned position and orientation at multiple points in time over a time horizon, as well as the vehicle's planned steering wheel angle and angle rate over the same time horizon. An autonomous vehicle's motion control system will consume the trajectory and send commands to the vehicle's steering controller, brake controller, throttle controller and/or other motion control subsystem to move the vehicle along a planned path.

A “trajectory” of an actor that a vehicle's perception or prediction systems may generate refers to the predicted path that the actor will follow over a time horizon, along with the predicted speed of the actor and/or position of the actor along the path at various points along the time horizon.

In this document, the terms “street,” “lane,” “road” and “intersection” are illustrated by way of example with vehicles traveling on one or more roads. However, the embodiments are intended to include lanes and intersections in other locations, such as parking areas. In addition, for autonomous vehicles that are designed to be used indoors (such as automated picking devices in warehouses), a street may be a corridor of the warehouse and a lane may be a portion of the corridor. If the autonomous vehicle is a drone or other aircraft, the term “street” or “road” may represent an airway and a lane may be a portion of the airway. If the autonomous vehicle is a watercraft, then the term “street” or “road” may represent a waterway and a lane may be a portion of the waterway.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes example embodiments for example fields and applications, it should be understood that the disclosure is not limited to the disclosed examples. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described in this document. Further, embodiments (whether or not explicitly described) have significant utility to fields and applications beyond the examples described in this document.

Embodiments have been described in this document with the aid of functional building blocks illustrating the implementation of specified functions and relationships. The boundaries of these functional building blocks have been arbitrarily defined in this document for the convenience of the description. Alternate boundaries can be defined as long as the specified functions and relationships (or their equivalents) are appropriately performed. Also, alternative embodiments can perform functional blocks, steps, operations, methods, etc. using orderings different than those described in in this document.

References in this document to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described in this document. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described example embodiments, but should be defined only in accordance with the following claims and their equivalents.

What is claimed is:

1. A method comprising, by one or more electronic devices:
receiving an image of a scene, wherein the image includes a pedestrian;
predicting a speed of the pedestrian by applying a machine-learning model to at least a portion of the image that includes the pedestrian, wherein the machine-learning model has been trained using a data set comprising training images of pedestrians, the training images associated with corresponding known pedestrian speeds; and
providing the predicted speed of the pedestrian to a motion-planning system that is configured to control a trajectory of an autonomous vehicle in the scene.

2. The method of claim 1, wherein predicting the speed of the pedestrian is performed by applying the machine-learning model to the image and no additional images.

3. The method of claim 1, wherein predicting the speed of the pedestrian further comprises:
determining a confidence level associated with the predicted speed; and
providing the confidence level to the motion-planning system.

4. The method of claim 3, wherein determining the confidence level associated with the predicted speed comprises:
predicting a speed of the pedestrian in a second image by applying the machine-learning model to at least a portion of the second image, and
comparing the predicted speed of the pedestrian in the second image to the predicted speed of the pedestrian in the received image.

5. The method of claim 1, further comprising, by one or more sensors of the autonomous vehicle moving in the scene, capturing the image.

6. The method of claim 1, wherein predicting the speed of the pedestrian is done in response to detecting the pedestrian within a threshold distance of the autonomous vehicle.

7. The method of claim 1, wherein detecting the pedestrian in the portion of the captured image comprises:
extracting one or more features from the image;
associating a bounding box or cuboid with the extracted features, the bounding boxes or cuboids defining a portion of the image containing the extracted features; and
applying a classifier to the portion of the image within the bounding box or cuboid, the classifier configured to identify images of pedestrians.

8. A system, comprising:
a memory; and
at least one processor coupled to the memory and configured to:
receive an image of a scene, wherein the image includes a pedestrian;
predict a speed of the pedestrian by applying a machine-learning model to at least a portion of the image that includes the pedestrian, wherein the machine-learning model has been trained using a data set comprising training images of pedestrians, the training images associated with corresponding known pedestrian speeds; and
provide the predicted speed of the pedestrian to a motion-planning system that is configured to control a trajectory of an autonomous vehicle in the scene.

9. The system of claim 8, wherein the at least one processor is configured to predict the speed of the pedestrian by applying the machine-learning model to the image and no additional images.

10. The system of claim 8, wherein the at least one processor is further configured to:
determine a confidence level associated with the predicted speed; and
provide the confidence level to the motion-planning system.

11. The system of claim 10, wherein the at least one processor is configured to determine the confidence level associated with the predicted speed by:
predicting a speed of the pedestrian in a second image by applying the machine-learning model to at least a portion of the second image, and
comparing the predicted speed of the pedestrian in the second image to the predicted speed of the pedestrian in the received image.

12. The system of claim 8, further comprising one or more sensors configured to capture the image.

13. The system of claim 8, wherein the at least one processor is configured to predict the speed of the pedestrian in response to detecting the pedestrian within a threshold distance of the autonomous vehicle.

14. A non-transitory computer-readable medium that stores instructions that are configured to, when executed by at least one computing device, cause the at least one computing device to perform operations comprising:
receiving an image of a scene, wherein the image includes a pedestrian;
predicting a speed of the pedestrian by applying a machine-learning model to at least a portion of the image that includes the pedestrian, wherein the machine-learning model has been trained using a data set comprising training images of pedestrians, the training images associated with corresponding known pedestrian speeds; and
providing the predicted speed of the pedestrian to a motion-planning system that is configured to control a trajectory of an autonomous vehicle in the scene.

15. The non-transitory computer-readable medium of claim 14, wherein predicting the speed of the pedestrian is performed by applying the machine-learning model to the image and no additional images.

16. The non-transitory computer-readable medium of claim 14, wherein predicting the speed of the pedestrian further comprises:
determining a confidence level associated with the predicted speed; and
providing the confidence level to the motion-planning system.

17. The non-transitory computer-readable medium of claim 14, wherein:
determining the confidence level associated with the predicted speed comprises:
predicting a speed of the pedestrian in a second image by applying the machine-learning model to at least a portion of the second image, and
comparing the predicted speed of the pedestrian in the second image to the predicted speed of the pedestrian in the received image.

18. The non-transitory computer-readable medium of claim 14, wherein the instructions cause the at least one computing device to perform operations further comprising capturing the image by one or more sensors of the autonomous vehicle.

19. The non-transitory computer-readable medium of claim 14, wherein predicting the speed of the pedestrian is done in response to detecting the pedestrian within a threshold distance of the autonomous vehicle.

20. The non-transitory computer-readable medium of claim 14, wherein detecting the pedestrian in the portion of the captured image comprises:
extracting one or more features from the image;
associating a bounding box or cuboid with the extracted features, the bounding boxes or cuboids defining a portion of the image containing the extracted features; and
applying a classifier to the portion of the image within the bounding box or cuboid, the classifier configured to identify images of pedestrians.
